(19) United States
(12) Patent Application Publication
(10) Pub. No.: US 2006/0095379 A1
(43) Pub. Date: May 4, 2006

(54) Key management method in network system

(75) Inventor: Hee-jean Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/256,167

(22) Filed: Oct. 24, 2005

Related U.S. Application Data
(60) Provisional application No. 60/620,663, filed on Oct. 22, 2004.

(30) Foreign Application Priority Data
Aug. 17, 2005 (KR) 2005-75073

(51) Int. Cl. G06Q 99/00

(52) U.S. Cl. 705/51

(57) ABSTRACT

A method of key management in a network system. In a network system which includes at least one node group having a plurality of nodes, the method of key management includes setting commonly-shared keys for subsets of all, or a part of the plurality of nodes; storing a part of the set keys for each node; and generating the rest of the set keys by substituting the part of the set keys for each node in a predetermined function. As a result, the number of keys for storage by each node can be greatly reduced in the transmission of encrypted contents and updated encrypted keys.

### CROSS-REFERENCE TO RELATED APPLICATIONS

This application claims benefit under 35 U.S.C. § 119 to U.S. provisional application No. 60/620,663 filed Oct. 22, 2004, and claims benefit under 35 U.S.C. § 119 from Korean Patent Application No. 2005-75073, filed Aug. 17, 2005, the entire contents of both applications are incorporated herein by reference.

### BACKGROUND OF THE INVENTION

1. Field of the Invention

The present invention relates to a key management method in a network system. More particularly, the present invention relates to a key management method in a network system, which uses a hash chain tree.

2. Description of the Related Art

FIG. 1 is a view illustrating an example of LKH (Logical Key Hierarchy) in the conventional art. Referring to FIG. 1, the LKH of FIG. 1 has 40 nodes. Only node 1, node 2, . . . , and node 27 of the first layer are actual nodes, while the rest of the nodes such as node 1′, node 2′, . . . , node 9′, and node a, node b, node c, and node A are imaginary nodes in the sense of including the actual nodes (node 1, node 2, . . . , node 27) which are connected therebelow. Such imaginary nodes may well be considered as node groups, each of which includes the actual nodes.

As the LKH is constructed, keys are allocated to the respective nodes. Referring to the way of allocating the keys, a key table 130 for the node 1′ will be first explained.

The node 1′ is an imaginary node, which is a node group of node 1, node 2 and node 3. Keys 1 to 7 are included for the key table 130 of the node 1′. The keys 1 to 7 are common keys shared by the subsets which include node 1, node 2 and node 3. The subsets exclude empty set.

Key 1 belongs only to node 1, key 2 belongs only to node 2, key 3 is shared by node 1 and node 2, key 4 belongs only to node 3, key 5 is shared by node 1 and node 3, key 6 is shared by node 2 and node 3, and key 7 is shared by all of node 1, node 2 and node 3.

In other words, node 1 has key 1, key 3, key 5, and key 7 on the key table 130 at node 1′, node 2 has key 2, key 3, key 6, and key 7 on the key table 130 at node 1′, and node 3 has key 4, key 5, key 6, and key 7 on the key table 130 at node 1′. Likewise, key tables are respectively set for node 2′ to node 9′.

Referring now to the key table 160 at node c, key 1 belongs only to node 7, key 2 belongs only to node 9, key 5 is shared by node 7 and node 9, key 6 is shared by node 8 and node 9, and key 7 is shared by all of node 7, node 8 and node 9.

As a result, node 19, node 20 and node 21 of node 7′ have key 1, key 3, key 5 and key 7 on the key table 160 at node c, respectively, and node 22, node 23 and node 24 of node 8′ have key 2, key 3, key 6 and key 7 on the key table 160 at node c, respectively, and node 25, node 26 and node 27 of node 9′ have key 4, key 5, key 6 and key 7 on the key table 130 at node c, respectively. The key table is set for node a and node b, in the same way as explained above with respect to node c.

Key 1 to key 7 are separate keys from each other, and key values as generated on all of the key tables are also separate from each other. In other words, key 1 at node 1′ is different from key 1 at node c, and keys at node 2′ and node 6′ are also independently separate from each other.

The key table 190 at node A will now be explained. Key 1 belongs only to node a, key 2 belongs only to node b, key 3 is shared by node a and node b, key 4 belongs only to node c, key 5 is shared by node a and node c, key 6 is shared by node b and node c, and key 7 is shared by all of node a, node b and node c.

As a result, node 1 to node 9 of node a have key 1, key 3, key 5 and key 7 on the key table 190 at node A, respectively, node 10 to node 18 of node b have key 2, key 3, key 6 and key 7 on the key table 190 at node A, respectively, and node 19 to node 27 of node c have key 4, key 5, key 6 and key 7 on the key table 190 at node A, respectively.

The actual nodes (node 1, node 2, . . . , node 27) of FIG. 1 may be considered as individual users in the relationship with the service provider. The service provider encrypts contents for the users using the above keys, and transmits the encrypted contents. Users subscribed to the service basically have the keys that are used by the service provider to encrypt the contents, and such keys are provided by the service provider upon service subscription or request for service extension.

Accordingly, the subscriber decrypts the contents using the given keys to use the contents encrypted by the service provider.

Meanwhile, the service provider needs to prevent use of service when revocation occurs, such as when the user cancels subscription to service, or fails to pay the fees.

To this end, the following contents need to be encrypted with new keys, and the new keys need to be provided to the users excluding certain users. In other words, key update is required.

If all the users of node c have revoked, that is, if users corresponding to node 19 to node 27 have revoked, the service provider encrypts a new key using key 3 of the key table 190 at node A, and transmits the new key.

If the user corresponding to node 2 has revoked, the service provider combines i) data obtained by encrypting new key using key 6 of key table 190 at node A, ii) data obtained by encrypting a new key using key 6 (belonging only to the node of node 2′ and node 3′) of the key table (not shown) at node a, and iii) data obtained by encrypting a new key using key 5 of the key table 130 at node 1′, and transmits the combined data.

According to the conventional art, however, node 1 needs to have i) key 1, key 3, key 5 and key 7 of the key table 130 at node 1′, ii) key 1, key 3, key 5 and key 7 of key table (not shown) at node a, and iii) key 1, key 3, key 5 and key 7 of key table 190 at node A.

More specifically, in a conventional way, node 1 needs to receive twelve keys and store the same, and this applies to all of the nodes of LKH.

Furthermore, in a conventional way as described above with reference to FIG. 1, when revocation occurs, the service provider needs to combine three types of encrypted data, each being encrypted using three keys, and then transmit the data.

Accordingly, increasing requirement for key storage on the node's part, and also increasing requirement for transmission rate on the service provider's part, need to be addressed.

### SUMMARY OF THE INVENTION

The present invention has been made to address the above-mentioned problems of the related art, and accordingly, it is an aspect of the present invention to provide a method of key management in a network system, which uses a hash chain tree.

The above aspects and/or other features of the present invention can substantially be achieved by providing a method of key management in a network system which includes at least one node group having a plurality of nodes, the method comprising: setting commonly-shared keys for subsets of all, or a part of the plurality of nodes; storing a part of the set keys for each node; and generating the rest of the set keys by substituting the part of the set keys for each node in a predetermined function.

The predetermined function may be a one-way hash function.

The step of generating the rest of the set keys may include substituting a predetermined integer in the predetermined function.

The generated keys may have serial numbers which are determined according to serial numbers of the keys substituted in the predetermined function and also the predetermined integer.

A part of the rest of the set keys may be generated selectively.

The serial numbers of the generated keys may be obtained by adding 2^{m} to the serial number of the substituted key, wherein m is the predetermined integer.

In the step of generating the rest of the set keys, the rest of the set keys may be generated by substituting previously-generated keys in the predetermined function.

The step of generating the rest of the set keys may be performed by a hash chain tree which defines sequential generation relation by the predetermined function.

One of the nodes may store information about the stored keys of other nodes.

The step of generating the rest of the set keys may include substituting the part of the set keys by using the information about the stored keys of other nodes.

The number of nodes of the node group may be four (4), and the predetermined integer is one of 0, 1, 2 and 3.

The number of nodes of the node group may be five (5), and the predetermined integer is one of 0, 1, 2, 3 and 4.

The number of nodes of the node group may be six (6), and the predetermined integer is one of 0, 1, 2, 3, 4 and 5.

The number of nodes of the node group may be seven (7), and the predetermined integer is one of 0, 1, 2, 3, 4, 5 and 6.

The number of nodes of the node group may be eight (8), and the predetermined integer is one of 0, 1, 2, 3, 4, 5, 6 and 7.

### BRIEF DESCRIPTION OF THE DRAWINGS

The above aspects and features of the present invention will be more apparent by describing certain exemplary embodiments of the present invention with reference to the accompanying drawings, in which:

FIG. 1 shows an example of conventional LKH (Logical Key Hierarchy);

FIG. 2A illustrates a pattern of applying mathematical expression 1 to a node group of four (4) nodes according to an exemplary embodiment of the present invention;

FIG. 2B illustrates a part of keys being stored for each node of a node group of four (4) nodes, and the relationship between the stored keys and the mathematical expression 1 according to an exemplary embodiment of the present invention;

FIG. 3A illustrates a pattern of applying mathematical expression 1 to a node group of five (5) nodes according to an exemplary embodiment of the present invention;

FIG. 3B illustrates a part of keys being stored for each node of a node group of five (5) nodes, and the relationship between the stored keys and the mathematical expression 1 according to an exemplary embodiment of the present invention;

FIG. 4A illustrates a pattern of applying mathematical expression 1 to a node group of six (6) nodes according to an exemplary embodiment of the present invention;

FIG. 4B illustrates a part of keys being stored for each node of a node group of six (6) nodes, and the relationship between the stored keys and the mathematical expression 1 according to an exemplary embodiment of the present invention;

FIGS. 5A to 5C illustrate a pattern of applying mathematic expression 1 to a node group of seven (7) nodes;

FIG. 5D illustrates a part of keys being stored for each node of a node group of seven (7) nodes, and the relationship between the stored keys and the mathematical expression 1 according to an exemplary embodiment of the present invention;

FIGS. 6A to 6H illustrate a pattern of applying mathematical expression 1 to a node group of eight (8) nodes according to an exemplary embodiment of the present invention;

FIGS. 6I to 6J illustrate a part of keys being stored for each node of a node group of eight (8) nodes, and the relationship between the stored keys and the mathematical expression 1 according to an exemplary embodiment of the present invention.

### DETAILED DESCRIPTION OF THE EXEMPLARY EMBODIMENTS

Certain exemplary embodiments of the present invention will be now described by reference to the accompanying drawings.

In the following description, same drawing reference numerals are used for the same elements even in different drawings. The matters defined in the description such as a detailed construction and elements are nothing but the ones provided to assist in a comprehensive understanding of the invention and are not intended to limit the scope of the invention in any way. Thus, it is apparent that the present invention can be carried out without those defined matters. Also, well-known functions or constructions are not described in detail since they would obscure the invention in unnecessary detail.

With reference to a node group of four (4) nodes, for example, keys to be stored by the respective nodes can be tabulated as follows:

TABLE 1

| | K1 | K2 | K3 | K4 | K5 | K6 | K7 | K8 | K9 | K10 | K11 | K12 | K13 | K14 | K15 |
|---|---|---|---|---|---|---|---|---|---|---|---|---|---|---|---|
| Node 1 | ◯ | X | ◯ | X | ◯ | X | ◯ | X | ◯ | X | ◯ | X | ◯ | X | ◯ |
| Node 2 | X | ◯ | ◯ | X | X | ◯ | ◯ | X | X | ◯ | ◯ | X | X | ◯ | ◯ |
| Node 3 | X | X | X | ◯ | ◯ | ◯ | ◯ | X | X | X | X | ◯ | ◯ | ◯ | ◯ |
| Node 4 | X | X | X | X | X | X | X | ◯ | ◯ | ◯ | ◯ | ◯ | ◯ | ◯ | ◯ |

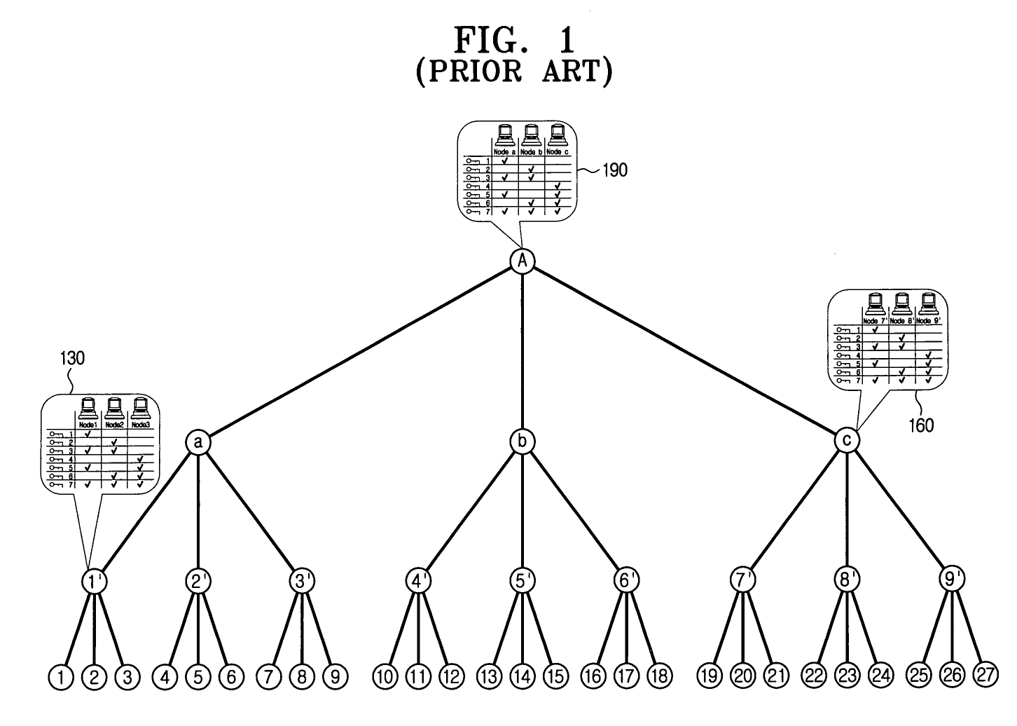

Referring to Table 1, in a node group of four (4) nodes according to the conventional case as shown and described with reference to FIG. 1, the node 1 needs to receive and store key 1, key 3, key 5, key 7, key 9, key 11, key 13 and key 15, node 2 needs to receive and store key 2, key 3, key 6, key 7, key 10, key 11, key 14 and key 15, node 3 needs to receive and store key 4, key 5, key 6, key 7, key 12, key 13, key 14 and key 15, and node 4 needs to receive and store key 8, key 9, key 10, key 11, key 12, key 13, key 14 and key 15, respectively.

With the key management method for a network system according to an exemplary embodiment of the present invention, however, requirement for storage at each node can be reduced through the use of hash function and hash chain tree sequentially using the hash function.

The ‘hash function’ is a transformation that takes a variable-size input and returns a fixed-size output. It is computationally infeasible to find some input with the output, and also computationally infeasible to find some inputs having the same output. It is also computationally infeasible to find two different inputs having the same output.

The hash function with the above property is used in applications such as flawlessness of data and authentication, and in the following exemplary embodiments of the present invention, nodes of the node group will share the hash function.

However, one will appreciate that the hash function in this description is only an example of one-way functions, and therefore, another form of a one-way function can be applied instead.

Accordingly, in the key management of a network system according to one exemplary embodiment of the present invention, in order to reduce a storage requirement for each of the nodes, the nodes as listed in the Table 1 store only a part of the allocated keys, and generate the rest of the keys using the one-way hash function of the following mathematical expression 1:
[Mathematical expression 1]

$${K}_{i} {\to }^{m} {K}_{j} \text{:} {K}_{j} = H ( {K}_{i} , m ) , j = {2}^{m} + i \qquad [ Mathematical expression 1 ]$$

With reference to the mathematical expression 1, the key Kⱼ with a serial number ‘j’ is generated by substituting the key Kᵢ with serial number ‘i’ and a predetermined integer ‘m’ in the hash function. When the number of nodes of one node group is ‘N’, the predetermined integer ‘m’ will be one of 0, 1, 2, . . . , N−1. ‘j’ is determined by ‘m’ and ‘i’, and as shown in the mathematical expression 1, ‘j’ will be the sum of 2m and ‘i’. In other words, key Kⱼ with the serial number ‘j’ is determined by the key Kᵢ with the serial number ‘i’ and predetermined integer ‘m’, and this relation can be expressed as

$${K}_{i} {\to }^{m} {K}_{j} .$$

Using the mathematical expression 1, each node stores a part of the allocated keys, and selectively generates the rest of the keys as necessary, by substituting the stored keys and predetermined integer ‘m’ in the one-way hash function.

In order for the nodes to receive a part of the allocated keys of the Table 1 and to generate the rest of the keys using mathematical expression 1, a pattern for applying the mathematical expression 1 needs be set in advance. By doing so, each node can selectively generate the keys allocated to itself using the part of the keys as stored.

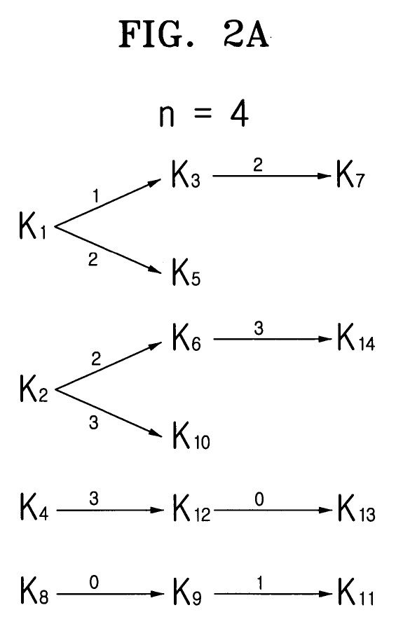

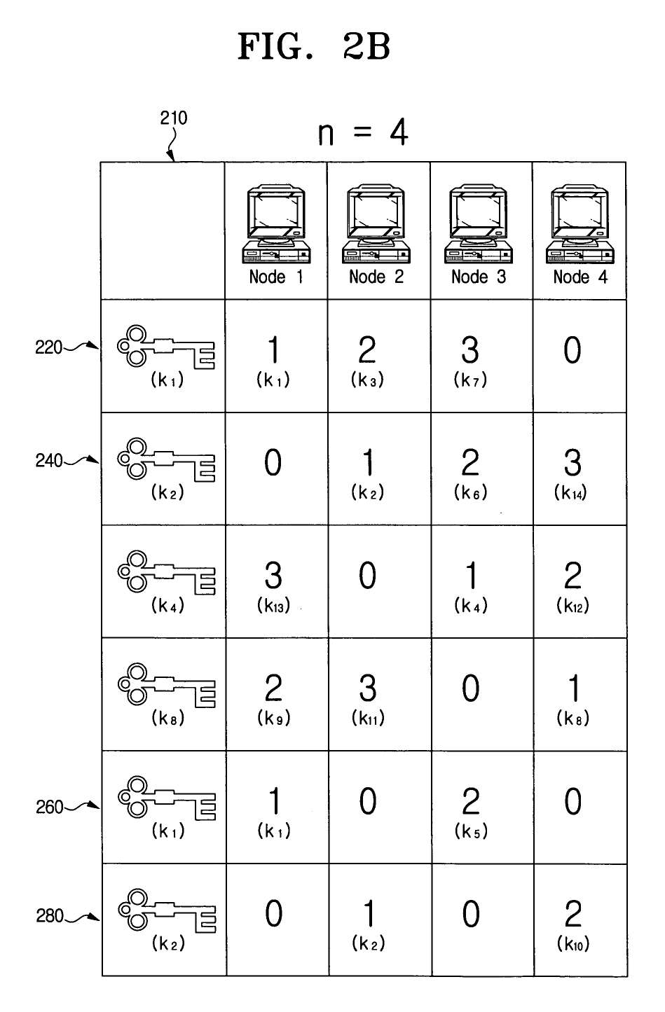

FIG. 2A illustrates a pattern of applying the mathematical expression 1 to a node group of four (4) nodes.

Referring to FIG. 2A, the application pattern of mathematical expression 1 to the node group of four (4) nodes will be descried below.

First, by substituting the key 1 and a number ‘1’ in the one-way hash function, key 3 is generated by the mathematical expression 1. Then by substituting the generated key 3 and a number ‘2’ in the one-way hash function, key 7 is generated by the mathematical expression 1. Meanwhile, by substituting key 1 and number ‘2’ in the one-way hash function, key 5 is generated by the mathematical expression 1.

When key 2 and number ‘2’ are substituted in the hash function, key 6 is generated by the mathematical expression 1, and by substituting the generated key 6 and number ‘3’ in the one-way hash function, key 14 is generated by the mathematical expression 1. Additionally, by substituting key 2 and number ‘3’ in the one-way hash function, key 10 is generated by the mathematical expression 1.

When key 4 and number ‘3’ are substituted in the one-way hash function, key 12 is generated by the mathematical expression 1, and by substituting the generated key 12 and number ‘0’ in one-way hash function, key 13 is generated by the mathematical expression 1.

When key 8 and number ‘0’ are substituted in the one-way hash function, key 9 is generated by the mathematical expression 1, and by substituting the generated key 9 and number ‘1’ in the one-way hash function, key 11 is generated by the mathematical expression 1. The application pattern of hash function as explained above with reference to FIG. 2A is the ‘hash chain tree’.

FIG. 2B illustrates a part of keys being stored for each node of a node group of four (4) nodes, and the relationship between the stored keys and the mathematical expression 1 according to an exemplary embodiment of the present invention.

Referring to FIG. 2B, first, the node 1 stores key 1, key 9 and key 13 among key 1, key 3, key 5, key 7, key 9, key 11, key 13 and key 15 of Table 1, and selectively generates the rest of the keys as necessary, by using mathematical expression 1.

The node 2 stores key 2, key 3 and key 11 among key 2, key 3, key 6, key 7, key 10, key 11, key 14 and key 15 of Table 1, and selectively generates the rest of the keys as necessary, by using mathematical expression 1.

The node 3 stores key 4, key 5, key 6 and key 7 among key 4, key 5, key 6, key 7, key 12, key 13, key 14 and key 15 of Table 1, and selectively generates the rest of the keys as necessary, by using mathematical expression 1.

The node 4 stores key 8, key 10, key 12 and key 14 among key 8, key 9, key 10, key 11, key 12, key 13, key 14 and key 15 of Table 1, and selectively generates the rest of the keys as necessary, by using mathematical expression 1.

Referring to FIG. 2B, K₁, K₂, K₄, K₈, K₁, K₂ under the key-shaped symbols of the first column 210 indicate the root keys for the keys of the same rows in the hash chain tree of FIG. 2A, respectively.

The numbers in the same rows to the respective key symbols of the first column 210 represent the relationship of the root keys and the keys of the same rows in the hash chain tree.

As shown in the first row 220 of FIG. 2B, the number ‘1’ corresponding to the node 1 shows that K₁, which is stored by the node 1, has been obtained as a result of hash function with respect to the root key K₁ on the hash chain tree of FIG. 2A as much as ‘1-1’ times, that is, ‘0’ times.

The number ‘2’ corresponding to the node 2 shows that K₃, which is stored by the node 2, has been obtained as a result of hash function with respect to the root key K₁ on the hash chain tree of FIG. 2A as much as ‘2-1’ times, that is, ‘1’ times.

The number ‘3’ corresponding to the node 3 shows that K₇, which is stored by the node 3, has been obtained as a result of hash function with respect to the root key K₁ on the hash chain tree of FIG. 2A as much as ‘3-1’ times, that is, ‘2’ times.

The number ‘0’ corresponding to the node 4 indicates that the node 4 does not store any key that has k₁ as the root key.

Referring to FIG. 2A, one will understand that the hash chain tree has two branches with root key K₁. Referring also to the first column 210 of FIG. 2B, K₁ is indicated as the root key in the first row 220 and the fifth row 260. The hash chain tree operation for the first row 220 is performed along the upward branch of FIG. 2A, while the hash chain tree operation for the fifth row 260 is performed along the downward branch of FIG. 2A.

The above equally applies to the hash chain tree operation in the second row 240 and the sixth row 280 which have K₂ has the root key.

Referring to the second row 240 of FIG. 2B, the number ‘0’ corresponding to the node 1 indicates that the node 1 does not store any key that has K₂ as the root key.

The number ‘1’ corresponding to the node 2 shows that K₂, which is stored by the node 1, has been obtained as a result of hash function with respect to the root key K₂ on the hash chain tree of FIG. 2A as much as ‘1-1’ times, that is, ‘0’ times.

The number ‘2’ corresponding to the node 3 shows that K₆, which is stored by the node 3, has been obtained as a result of hash function with respect to the root key K₂ on the hash chain tree of FIG. 2A as much as ‘2-1’ times, that is, ‘1’ times.

The number ‘3’ corresponding to the node 4 shows that K₁₄, which is stored by the node 4, has been obtained as a result of hash function with respect to the root key K₂ on the hash chain tree of FIG. 2A as much as ‘3-1’ times, that is, ‘2’ times.

The numbers in the other rows of FIG. 2B will be interpreted in the same way as explained above.

One thing to note is that, due to the characteristic of the one-way hash function, each node is allowed to use the keys which are sequentially generated by the hash operation on the hash chain tree of FIG. 2A, from the keys that each node is storing. Additionally, each node has information about the hash chain tree and keys stored in each node as shown in FIGS. 2A and 2B.

As a result, when keys are additionally required beside the stored keys, each node can generate necessary keys by hash function, using the information as shown in FIGS. 2A and 2B.

In other words, when a key manager transmits encrypted data, and if this data is encrypted using K₁₃ of the Table 1 so that only node 1, node 3 and node 4 excluding node 2 can decrypt, the node 1 first receiving the encrypted data using K₁₃ recognizes K₁₃ and finds out that K₁₃ is allocated only to node 1, node 3 and node 4.

Accordingly, it is checked in FIG. 2B as to which root key is commonly stored by node 1, node 3 and node 4. When K₄ is confirmed as the root key, the node 1 finds out through the corresponding number ‘3’ that the key stored therein is the result of hash function on the hash chain tree of FIG. 2A as much as ‘3-1’ times, that is, ‘2’ times, and thus recognizes that it is storing K₁₃. In this case, node 1 can decrypt the received data using the stored K₁₃.

When node 3 receives data which is encrypted by K₁₃, the node 3 recognizes K₁₃ and finds out that K₁₃ is allocated only to node 1, node 3 and node 4.

Accordingly, it is checked in FIG. 2B as to which root key is commonly stored by node 1, node 3 and node 4. When K₄ is confirmed as the root key, the node 3 finds out through the corresponding number ‘1’ that the key stored therein is the result of hash function on the hash chain tree of FIG. 2A as much as ‘1-1’ times, that is, ‘0’ times, and thus recognizes that it is storing K₄. Accordingly, in order to generate K₁₃, the node 3 generates K₁₂ by using K₄ with reference to the information about the hash chain tree of FIG. 2A, and thus generates K₁₃. In this case, node 3 can decrypt the received data using the stored K₁₃.

When node 4 receives data which is encrypted by K₁₃, the node 4 recognizes K₁₃ and finds out that K₁₃ is allocated only to node 1, node 3 and node 4.

Accordingly, it is checked in FIG. 2B as to which root key is commonly stored by node 1, node 3 and node 4. When K₄ is confirmed as the root key, the node 4 finds out through the corresponding number ‘2’ that the key stored therein is the result of hash function on the hash chain tree of FIG. 2A as much as ‘2-1’ times, that is, ‘1’ times, and thus recognizes that it is storing K₁₂. Accordingly, in order to generate K₁₃, the node 4 generates K₁₃ by using K₁₂ with reference to the information about the hash chain tree of FIG. 2A. In this case, node 4 can decrypt the received data using the stored K₁₃.

The encrypted data may be a new key, or data about certain contents.

Meanwhile, the technical idea of the present invention may also be applied to data communication in which two or three nodes of a node group communicate through a commonly-shared key. For example, when node 1, node 2 and node 3 want to communicate, excluding the other nodes of the same node group from communication, node 1, node 2 and node 3 find out through FIG. 2B a common key that only three share.

Accordingly, node 1, node 2 and node 3 find out that they store K₁, K₃ and K7, respectively, with K₁ as a root key, and therefore, node 1 computes ‘3-1’ times, that is, ‘2’ times along the upward branch of the hash chain tree of FIG. 2A, and thus generates and obtains K₇ as the commonly-shared key.

In order to generate K₇ as a commonly-shared key, node 2 computes ‘2-1’ times, that is, computes ‘1’ times along the upward branch of the hash chain tree of FIG. 2A, and thus generates and obtains K₇. Accordingly, node 1, node 2 and node 3 share K₇ as their exclusive common key, and through K₇, communicate with each other, while excluding other nodes from communication.

If node 2 and node 4 want to communicate through their exclusive common key, and exclude other nodes from the communication, node 2 and node 4 find out a common key shared by only two of them through FIG. 2B. In other words, node 2 and node 4 know that they store K₂ and K₁₀, respectively, with having K₂ as the root key, and therefore, node 2 computes ‘2-1’ times, that is, ‘1’ times along the downward branch of the hash chain tree of FIG. 2A to generate K₁₀ as the common key.

As a result, node 2 and node 4 share K₁₀ as the common key, and through K₁₀, communicate with each other, while excluding the other nodes from the communication.

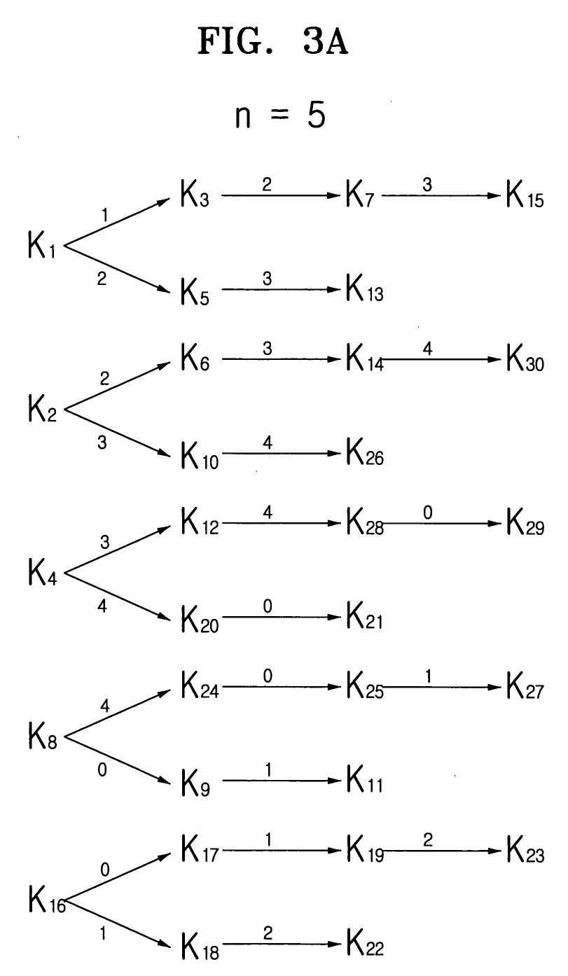

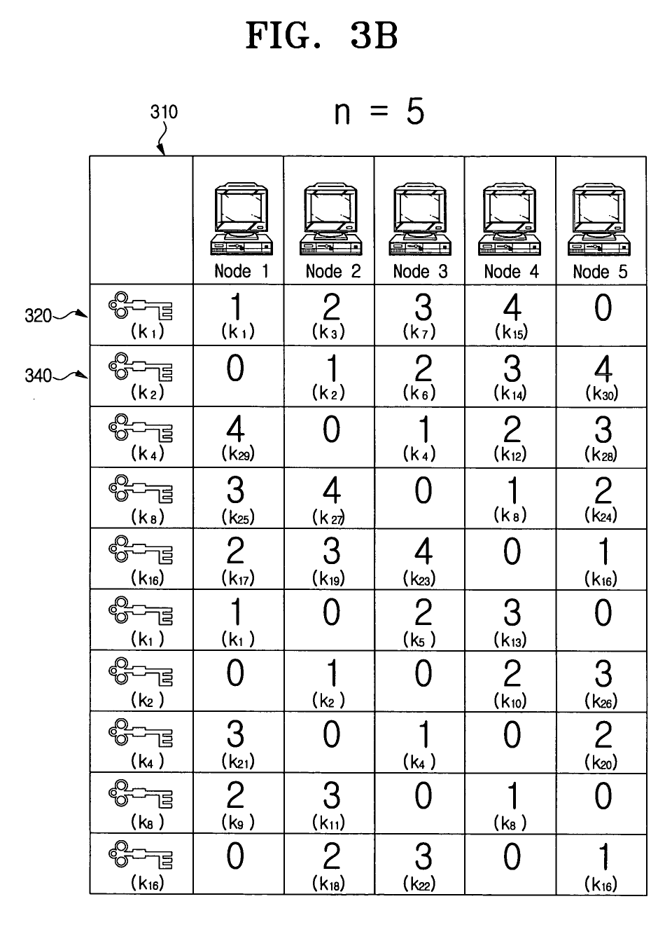

FIG. 3A illustrates a pattern of applying mathematical expression 1 to a node group of five (5) nodes according to an exemplary embodiment of the present invention.

Referring to FIG. 3A, first, when key 1 and number ‘1’ are substituted in the hash function, key 3 is generated by the mathematical expression 1, and then by substituting the generated key 3 and number ‘2’ in one-way hash function, key 7 is generated by the mathematical expression 1, and by substituting the generated key 7 and the number ‘3’ in the one-way hash function, key 15 is generated by the mathematical expression 1. Meanwhile, when key 1 and number ‘2’ are substituted in the hash function, key 5 is generated by the mathematical expression 1, and by substituting the generated key 5 and number ‘3’ in the one-way hash function, key 13 is generated by the mathematical expression 1.

Meanwhile, by substituting key 2 and number ‘2’ in the one-way hash function, key 6 is generated by the mathematical expression 1, and by substituting the generated key 6 and number ‘3’ in the one-way hash function, key 14 is generated by the mathematical expression 1, and by substituting the generated key 14 and number ‘4’ in the one-way hash function, key 30 is generated by the mathematical expression 1.

Additionally, by substituting key 2 and number ‘3’ in the one-way hash function, key 10 is generated by the mathematical expression 1, and by substituting the generated key 10 and number ‘4’ in the one-way hash function, key 26 is generated by the mathematical expression 1.

Meanwhile, by substituting key 4 and number ‘3’ in the one-way hash function, key 12 is generated by the mathematical expression, and by substituting the generated key 12 and number ‘4’ in the one-way hash function, key 28 is generated by the mathematical expression 1, and by substituting the generated key 28 and number ‘0’ in the one-way hash function, key 29 is generated by the mathematical expression 1.

Further, by substituting key 4 and number ‘4’ in the one-way hash function, key 20 is generated by the mathematical expression 1, and by substituting the generated key 20 and number ‘0’ in the one-way hash function, key 21 is generated by the mathematical expression 1.

Meanwhile, by substituting key 8 and number ‘4’ in the one-way hash function, key 24 is generated by the mathematical expression, and by substituting the generated key 24 and number ‘0’ in the one-way hash function, key 25 is generated by the mathematical expression 1, and by substituting the generated key 25 and number ‘1’ in the one-way hash function, key 27 is generated by the mathematical expression 1.

Further, by substituting key 8 and number ‘0’ in the one-way hash function, key 9 is generated by the mathematical expression 1, and by substituting the generated key 9 and number ‘1’ in the one-way hash function, key 11 is generated by the mathematical expression 1.

Meanwhile, by substituting key 16 and number ‘0’ in the one-way hash function, key 17 is generated by the mathematical expression, and by substituting the generated key 17 and number ‘1’ in the one-way hash function, key 19 is generated by the mathematical expression 1, and by substituting the generated key 19 and number ‘2’ in the one-way hash function, key 23 is generated by the mathematical expression 1.

Further, by substituting key 16 and number ‘1’ in the one-way hash function, key 18 is generated by the mathematical expression 1, and by substituting the generated key 18 and number ‘2’ in the one-way hash function, key 22 is generated by the mathematical expression 1.

FIG. 3B illustrates a part of keys being stored for each node of a node group of five (5) nodes, and the relationship between the stored keys and the mathematical expression 1 according to an exemplary embodiment of the present invention.

Referring to FIG. 3B, node 1 first stores key 1, key 9, key 17, key 21, key 25 and key 29 only, and selectively generates the rest of the keys using the mathematical expression 1.

Node 2 stores key 2, key 3, key 11, key 18, key 19 and key 27 only, and selectively generates the rest of the keys using the mathematical expression 1.

Node 3 stores key 4, key 5, key 6, key 7, key 22 and key 23 only, and selectively generates the rest of the keys using the mathematical expression 1.

Node 4 stores key 8, key 10, key 12, key 13, key 14 and key 15 only, and selectively generates the rest of the keys using the mathematical expression 1.

Node 5 stores key 16, key 20, key 24, key 26, key 28 and key 30 only, and selectively generates the rest of the keys using the mathematical expression 1.

K₁, K₂, K₄, K₈, K₁₆, K₁, K₂, K₄, K₈, K₁₆ marked under the key-shaped symbols of the first column 310 of FIG. 3B refer to the root keys of the keys in the same rows on the hash chain tree.

Additionally, the numbers marked in the same rows as the key symbols of the first column 310 represent the relation between the root keys and the keys in the same rows on the hash chain tree.

Referring first to the first row 320 of FIG. 3B, the number ‘1’ corresponding to node 1 indicates that K₁, which is stored by node 1, is the result of computing hash operation with respect to the root key K₁ on the hash chain tree of FIG. 3A as much as ‘1-1’ times, that is, ‘0’ times.

The number ‘2’ corresponding to node 2 indicates that K₃, which is stored by node 2, is the result of computing hash operation with respect to the root key K₁ on the hash chain tree of FIG. 3A as much as ‘2-1’ times, that is, ‘1’ times.

The number ‘3’ corresponding to node 3 indicates that K₇, which is stored by node 3, is the result of computing hash operation with respect to the root key K₁ on the hash chain tree of FIG. 3A as much as ‘3-1’ times, that is, ‘2’ times.

The number ‘4’ corresponding to node 4 indicates that K₁₅, which is stored by node 4, is the result of computing hash operation with respect to the root key K₁ on the hash chain tree of FIG. 3A as much as ‘4-1’ times, that is, ‘3’ times.

The number ‘0’ corresponding to node 5 indicates that node 5 does not store any key that has K₁ as the root key.

Meanwhile, referring to FIG. 3A, the hash chain tree with K₁ as the root key has two branches. Additionally, referring to the first column 310 of FIG. 3B, K₁ is marked as the root key in the first row 320 and the sixth row. The hash chain tree in the first row 320 is computed along the upward branch of FIG. 3A, while the hash chain tree in the sixth row is computed along the downward branch of FIG. 3A. The above equally applies to all the root keys repeating in the first column 310.

Referring to the second row 340 of FIG. 3B, the number ‘0’ corresponding to node 1 indicates that node 1 does not store any key that has K₂ as the root key.

The number ‘1’ corresponding to node 2 indicates that K₂, which is stored by node 2, is the result of computing hash operation with respect to the root key K₂ on the hash chain tree of FIG. 3A as much as ‘1-1’ times, that is, ‘0’ times.

The number ‘2’ corresponding to node 3 indicates that K₆, which is stored by node 3, is the result of computing hash operation with respect to the root key K₂ on the hash chain tree of FIG. 3A as much as ‘2-1’ times, that is, ‘1’ times.

The number ‘3’ corresponding to node 4 indicates that K₁₄, which is stored by node 4, is the result of computing hash operation with respect to the root key K₂ on the hash chain tree of FIG. 3A as much as ‘3-1’ times, that is, ‘2’ times.

The number ‘4’ corresponding to node 5 indicates that K₃₀, which is stored by node 4, is the result of computing hash operation with respect to the root key K₂ on the hash chain tree of FIG. 3A as much as ‘4-1’ times, that is, ‘3’ times.

The rest of the numbers of the other rows of FIG. 3B can be interpreted in the same way as explained above.

One thing to note is that due to the characteristics of the one-way hash function, each node can use the keys which are generated in sequence from the keys stored in each node by hash operation on the hash chain tree. Additionally, each node has information about the hash chain tree and the keys stored in each node shown in FIGS. 3A and 3B.

As a result, when keys are necessary besides the stored keys, each node generates the necessary keys by the hash operation, using the information of FIGS. 3A and 3B.

How to generate necessary keys by hash operation has been explained above with reference to FIGS. 2A and 2B. The method as illustrated in FIGS. 2A and 2B may be applied to exclusive data communication among two, three or four nodes of a node group of five nodes, with using the common key exclusively shared by the communication-intending nodes.

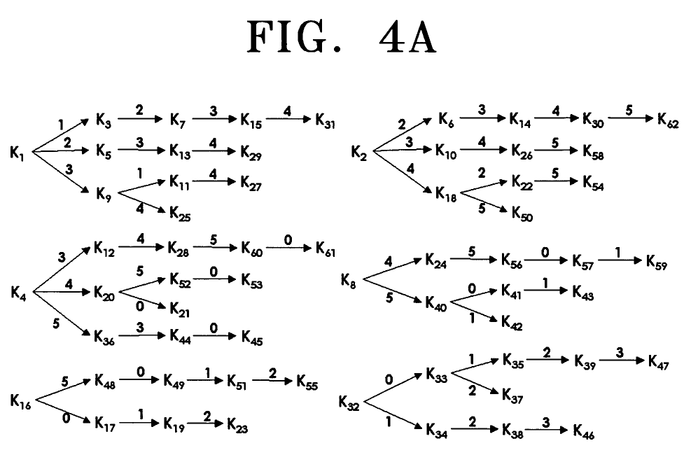

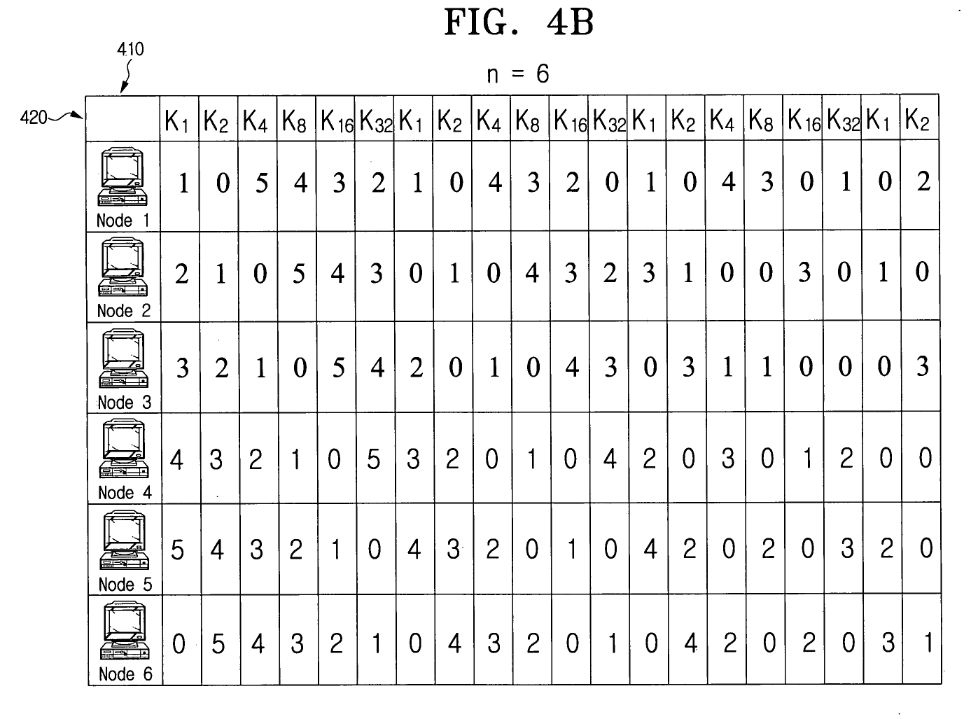

FIG. 4A illustrates a pattern of applying mathematical expression 1 to a node group of six (6) nodes according to an exemplary embodiment of the present invention.

Referring to FIG. 4A, first, by substituting key 1 and number ‘1’ in the one-way hash function, key 3 is generated by the mathematical expression 1, and by substituting the generated key 3 and number ‘2’ in the one-way hash function, key 7 is generated by the mathematical expression 1, and by substituting the generated key 7 and number ‘3’ in the one-way hash function, key 15 is generated by the mathematical expression 1, and by substituting the generated key 15 and number ‘4’ in the one-way hash function, key 31 is generated by the mathematical expression 1.

Additionally, by substituting key 1 and number ‘2’ in the one-way hash function, key 5 is generated by the mathematical expression 1, and by substituting the generated key 5 and number ‘3’ in the one-way hash function, key 13 is generated by the mathematical expression 1, and by substituting the generated key 13 and number ‘4’ in the one-way hash function, key 29 is generated by the mathematical expression 1.

Additionally, by substituting key 1 and number ‘3’ in the one-way hash function, key 9 is generated by the mathematical expression 1, and by substituting the generated key 9 and number ‘1’ in the one-way hash function, key 11 is generated by the mathematical expression 1, and by substituting the generated key 11 and number ‘4’ in the one-way hash function, key 27 is generated by the mathematical expression 1.

Meanwhile, by substituting key 9 and number ‘4’ in the one-way hash function, key 25 is generated by the mathematical expression 1. The above equally applies to the hash chain tree having key 2, key 4, key 8, key 16 and key 32 as a root key.

FIG. 4B illustrates a part of keys being stored for each node of a node group of six (6) nodes, and relation between the stored keys and the mathematical expression 1 according to an exemplary embodiment of the present invention

The numbers corresponding to the nodes of the first column 410 according to each group key include 0, 1, 2, 3, 4, 5. Each number indicates the position from the root key in the hash chain tree. Accordingly, number ‘1’ indicates the root key, ‘2’ is a key once hash-converted from the root key, ‘3’ is a key twice hash-converted from the root key, ‘4’ is a key three times hash-converted from the root key, and ‘5’ is a key four times hash-converted from the root key. The number ‘0’ indicates absence of root key and a key hash-converted from the root key.

The hash chain tree of FIG. 4A has a plurality of conversion paths. Therefore, it should be determined as to which path should be taken for hash conversion.

The conversion paths may branch off from the root key, or from the keys other than the root key. Along the order of hash conversion, the first juncture will be called a ‘upper juncture’ and the second juncture will be called a ‘lower juncture’ hereinbelow.

Referring to FIG. 4B, a set of root keys repeats in the first row 420. In the hash conversion along the hash chain tree, hash conversion is made along the upper-most path of a certain root key, and then made along the second upper-most path.

At the lower juncture, priority goes to the upper path and therefore, the upper path is chosen for hash conversion. The un-chosen path of the lower juncture is taken in a sequential order after all the paths of the root key are taken and the root key repeats.

As a result, it can be determined through FIG. 4B that node 1 is storing key 1, key 17, key 18, key 32, key 33, key 41, key 42, key 45, key 49, key 53, key 57 and key 61. The keys stored by the node 2, node 3, node 4, node 5 and node 6 can also be checked through FIG. 4B by the above-explained way.

In the manner as explained above, keys stored by the respective nodes are determined, and as necessary, each node may selectively generate necessary keys using the mathematical expression 1. Later, by the characteristic of the one-way hash function, each node can use the keys which are generated in sequence by the hash operation with respect to the stored keys along the hash chain tree of FIG. 4A. Each node has information about the hash chain tree and the keys stored in the node as shown in FIGS. 4A and 4B.

As a result, when additional keys are necessary beside the stored keys, each node can generate necessary keys using the information of FIGS. 4A and 4B.

How to generate necessary keys with the hash operation has already been explained above with reference to FIGS. 2A and 2B. This may equally be applied to the exclusive data communication among certain number of nodes of a node group of six nodes, with a common key exclusively shared by the communication-intending nodes, as explained above with reference to FIGS. 2A and 2B.

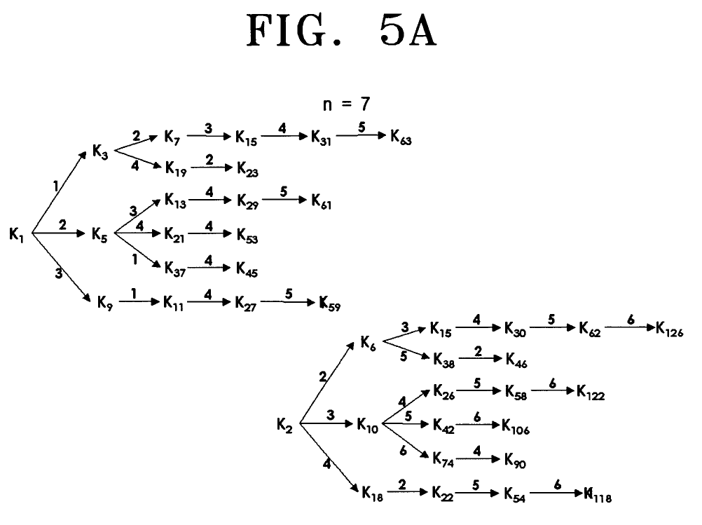

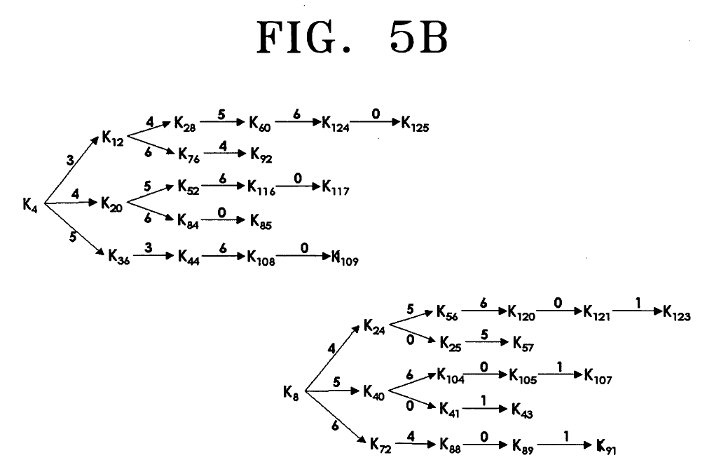

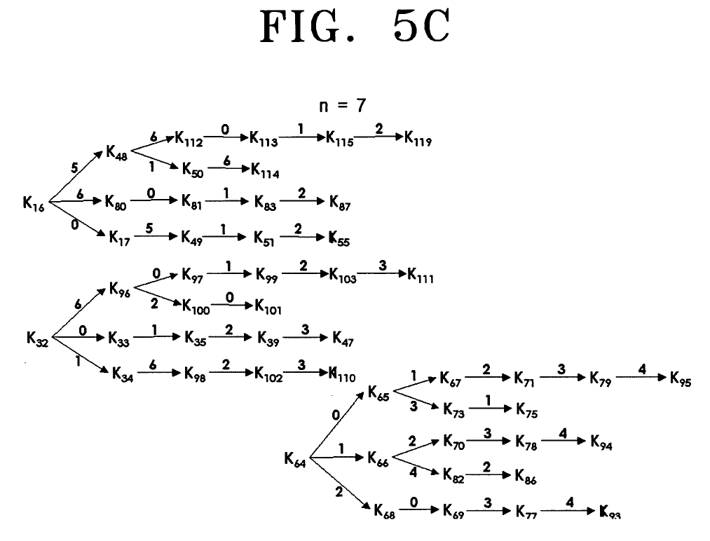

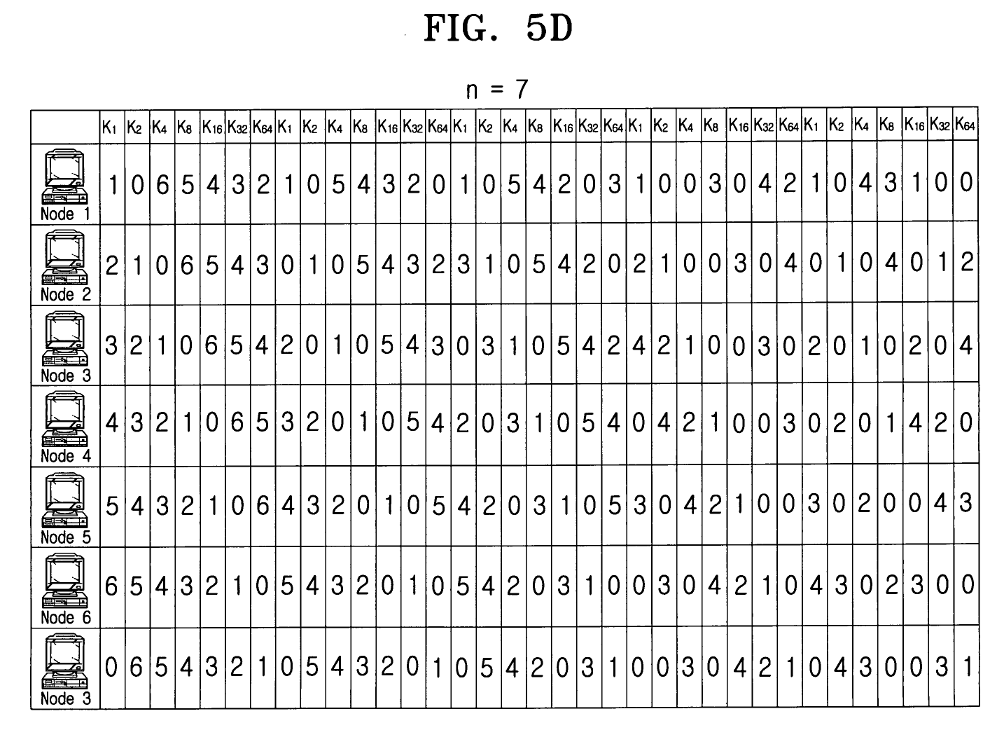

FIGS. 5A to 5C illustrate a pattern of applying mathematic expression 1 to a node group of seven (7) nodes, and explanation thereof can be referred to the above description.

FIG. 5D illustrates a part of keys being stored for each node of a node group of seven (7) nodes, and the relationship between the stored keys and the mathematical expression 1 according to an exemplary embodiment of the present invention, and explanation thereof can be referred to the above description.

In the manner as explained above, keys stored by the respective nodes are determined, and as necessary, each node may selectively generate necessary keys using the mathematical expression 1. Later, by the characteristic of the one-way hash function, each node can use the keys which are generated in sequence by the hash operation with respect to the stored keys along the hash chain tree of FIGS. 5A to 5C. Each node has information about the hash chain tree and the keys stored in the node as shown in FIGS. 5A to 5D.

As a result, when additional keys are necessary besides the stored keys, each node can generate necessary keys using the information of FIGS. 5A to 5D.

How to generate necessary keys with the hash operation has already been explained above with reference to FIGS. 2A and 2B. This may equally be applied to the exclusive data communication among certain number of nodes of a node group of seven nodes, with a common key exclusively shared by the communication-intending nodes, as explained above with reference to FIGS. 2A and 2B.

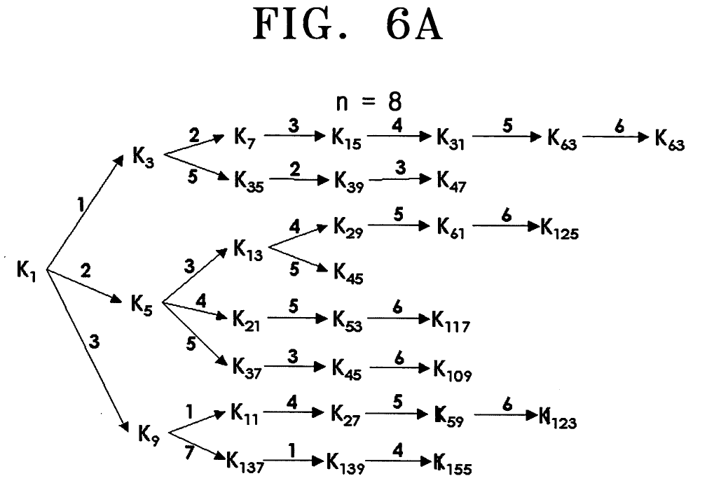

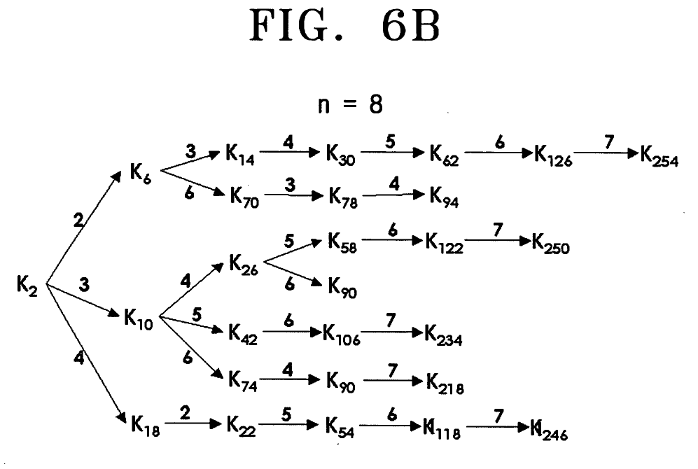

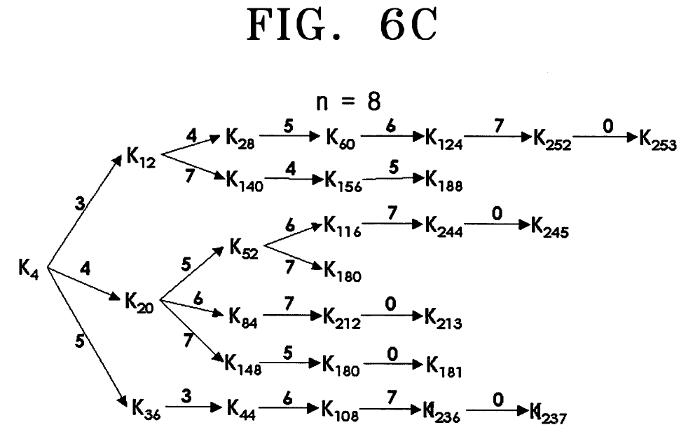

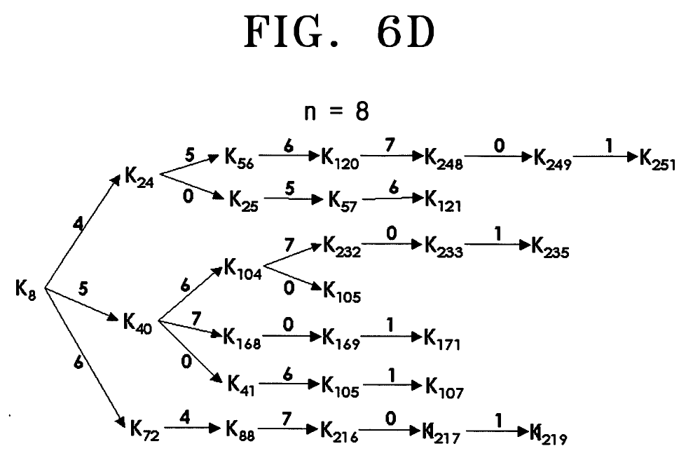

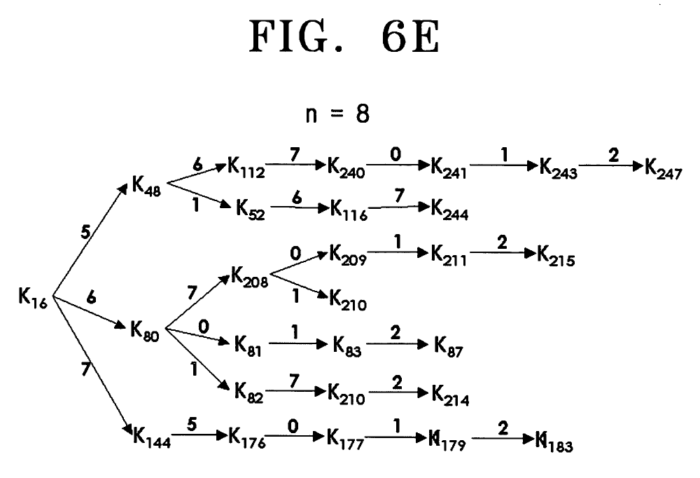

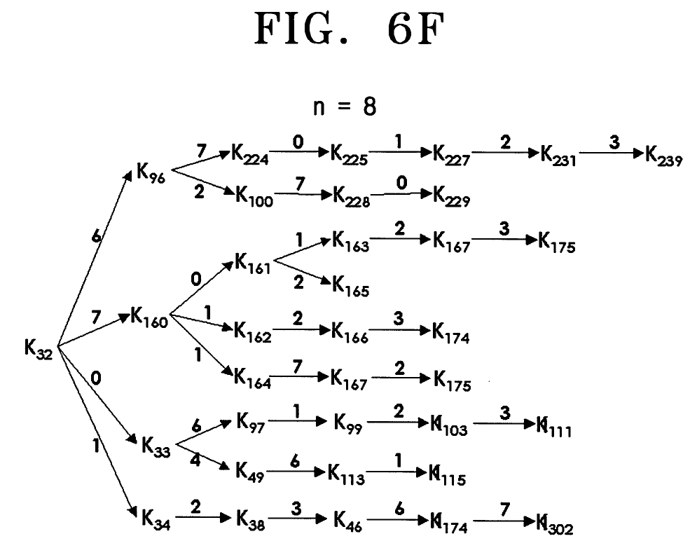

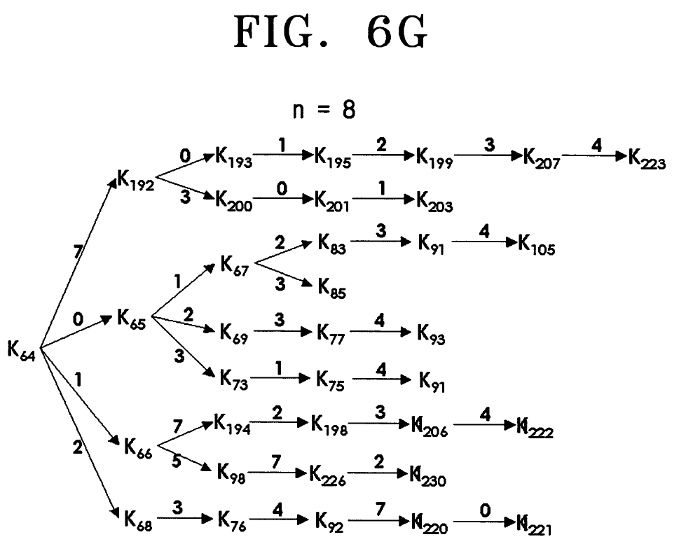

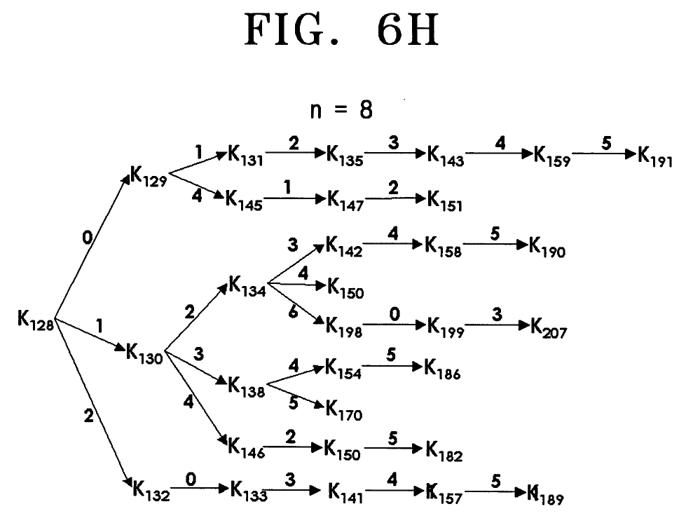

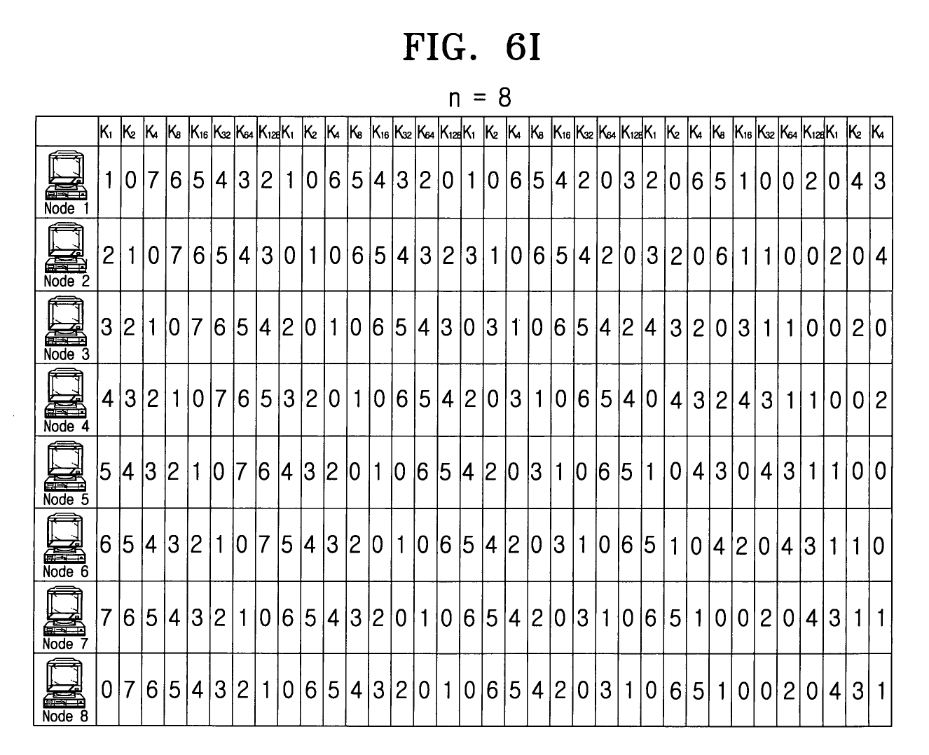

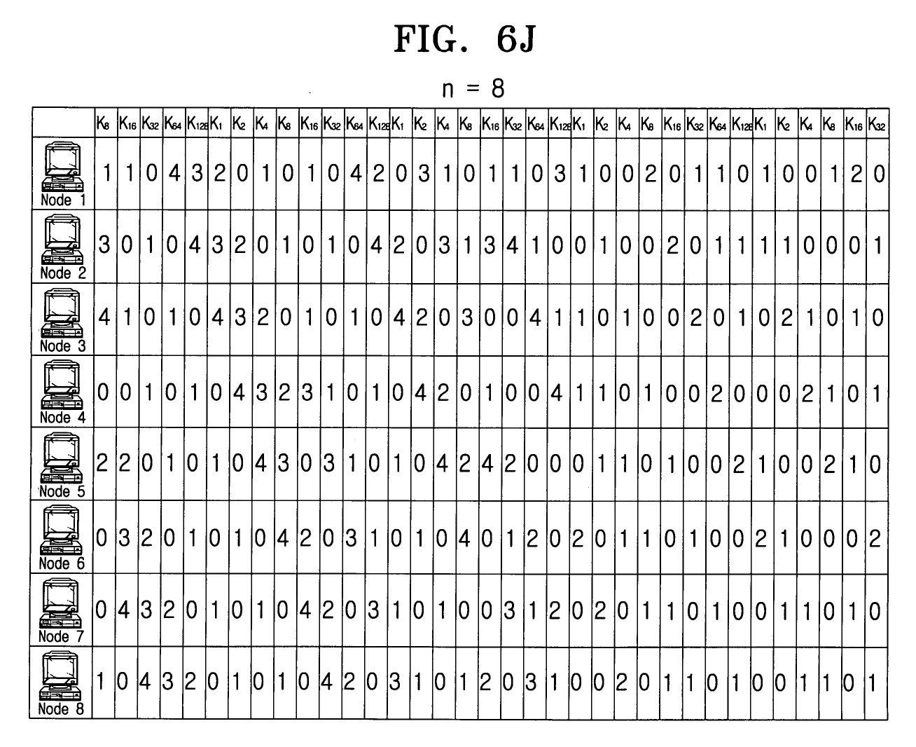

FIGS. 6A to 6H illustrate a pattern of applying mathematical expression 1 to a node group of eight (8) nodes according to an exemplary embodiment of the present invention, and the explanation thereof can be referred to the above description.

FIGS. 6I to 6J illustrate a part of keys being stored for each node of a node group of eight (8) nodes, and relation between the stored keys and the mathematical expression 1 according to an exemplary embodiment of the present invention, and explanation thereof can be referred to the above description.

In the manner as explained above, keys stored by the respective nodes are determined, and as necessary, each node may selectively generate necessary keys using the mathematical expression 1. Later, by the characteristic of the one-way hash function, each node can use the keys which are generated in sequence by the hash operation with respect to the stored keys along the hash chain tree of FIGS. 6A to 6H. Each node has information about the hash chain tree and the keys stored in the node as shown in FIGS. 6A to 6J.

As a result, when additional keys are necessary besides the stored keys, each node can generate necessary keys using the information of FIGS. 6A to 6J.

How to generate necessary key with hash operation has already been explained above with reference to FIGS. 2A and 2B. This may equally be applied to the exclusive data communication among certain number of nodes of a node group of eight nodes, with a common key exclusively shared by the communication-intending nodes, as explained above with reference to FIGS. 2A and 2B.

As described above in a few exemplary embodiments of the present invention, the number of keys for storage by each node can be greatly reduced in the transmission of encrypted contents and updated encrypted keys.

The foregoing exemplary embodiments and advantages are merely exemplary and are not to be construed as limiting the present invention. The present teaching can be readily applied to other types of apparatuses or methods. Also, the description of the exemplary embodiments of the present invention is intended to be illustrative, and not to limit the scope of the claims, and many alternatives, modifications, and variations will be apparent to those skilled in the art.

What is claimed is:

1. A method of key management in a network system which includes at least one node group having a plurality of nodes, the method comprising:
setting commonly-shared keys for subsets of at least a part of the plurality of nodes;
storing a part of the set keys for each node; and
generating the rest of the set keys by substituting the part of the set keys for each node in a predetermined function.

2. The method of claim 1, wherein the predetermined function comprises a one-way hash function.

3. The method of claim 1, wherein the step of generating the rest of the set keys comprises substituting a predetermined integer in the predetermined function.

4. The method of claim 3, wherein the generated keys have serial numbers which are determined according to serial numbers of the keys substituted in the predetermined function and also the predetermined integer.

5. The method of claim 1, wherein a part of the rest of the set keys are generated selectively.

6. The method of claim 4, wherein the serial numbers of the generated keys are obtained by adding 2^{m} to the serial number of the substituted key, wherein m is equal to the predetermined integer.

7. The method of claim 1, wherein, in the step of generating the rest of the set keys, the rest of the set keys are generated by substituting previously-generated keys in the predetermined function.

8. The method of claim 2, wherein the step of generating the rest of the set key is performed by a hash chain tree which defines sequential generation relation by the predetermined function.

9. The method of claim 1, wherein one of the nodes stores information about the stored keys of other nodes.

10. The method of claim 9, wherein the step of generating the rest of the set keys substitutes the part of the set keys by using the information about the stored keys of other nodes.

11. The method of claim 3, wherein the number of nodes of the node group is four (4), and the predetermined integer is one of 0, 1, 2 and 3.

12. The method of claim 3, wherein the number of nodes of the node group is five (5), and the predetermined integer is one of 0, 1, 2, 3 and 4.

13. The method of claim 3, wherein the number of nodes of the node group is six (6), and the predetermined integer is one of 0, 1, 2, 3, 4 and 5.

14. The method of claim 3, wherein the number of nodes of the node group is seven (7), and the predetermined integer is one of 0, 1, 2, 3, 4, 5 and 6.

15. The method of claim 3, wherein the number of nodes of the node group is eight (8), and the predetermined integer is one of 0, 1, 2, 3, 4, 5, 6 and 7.
